(19) United States
(12) Patent Application Publication
(10) Pub. No.: US 2010/0042928 A1
(43) Pub. Date: Feb. 18, 2010

(54) SYSTEMS AND METHODS FOR CALCULATING AND PRESENTING A USER-CONTRIBUTOR RATING INDEX

(76) Inventor: Peter Rinearson, Vashon, WA (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/540,171

(22) Filed: Aug. 12, 2009

Related U.S. Application Data
(60) Provisional application No. 61/088,293, filed on Aug. 12, 2008.

(51) Int. Cl. G06F 15/177

(52) U.S. Cl. 715/737

(57) ABSTRACT

The quality and/or nature of the contributions submitted by a particular user-contributor may be summarized by a quality rating, a prime slice count, and/or a prime slice ratio. The quality rating may be derived from a subset of top-rated submissions by the user. The prime slice count may indicate how many of the user's submissions are within a top-rated, prime slice of the website corpus. The prime slice ratio may represent a ratio of the prime slice count to the total number of submissions from the user-contributor. Indications of the quality rating, prime slice count, and/or prime slice ration may be displayed in connection with content submitted by the user and/or a user profile. The indicators may include graphics, text, or the like. This invention allows for recognition of a valuable contributor without penalizing the contributor for submissions that do not reflect the contributor's very best work.

### CROSS-REFERENCE TO RELATED APPLICATIONS

This application claims the benefit of U.S. Provisional Application No. 61/088,293, filed Aug. 12, 2008, which is fully incorporated herein by reference.

### TECHNICAL FIELD

This disclosure relates to systems and methods for calculating and presenting a user-contributor rating index to provide an accurate and easy-to-digest assessment of the quality and consistency of the higher-quality items submitted by a user of a website that accepts community content. It omits evaluation of lower-rated items, so as not to discourage contributions that are valuable but which might bring down a rating based on an overall average.

### SUMMARY OF THE INVENTION

A user-contributor rating index may be used to provide an easy-to-digest summary of a user's more-valuable contributions to a corpus. The user contributions may comprise a plurality of items submitted by the user, each of which may have a respective rating. Within the plurality of user submissions, a subset of the highest-rated items may be identified (e.g., as a top percentile of the user submissions, or as a specific number of user submissions). A quality rating may be calculated using the ratings of the items in the subset (e.g., an average of the ratings of the items in the subset of highest-rated items).

The quality rating of the user may be displayed in connection with content submitted by the user and/or in a user profile of the user. Since the quality rating is derived from the subset of the highest-rated items submitted by the user, the quality rating may provide an accurate depiction of the capabilities of the user to do high-quality work, without penalizing the user for submissions which are valuable but which might otherwise bring down an overall average rating (if a rating were based on the average of all submissions rather than the average of the better submission).

A corpus of user-contributed content may include items submitted by different submitters. Each of the items may have a respective rating. A prime slice of the corpus may be identified, which may include a set of the highest-rated items within the corpus. The highest-rated items may be selected from the corpus based on a percentile rating threshold, a deviation threshold, or the like.

A prime slice count for a user may be calculated. The prime slice count may indicate how many submissions of the user fall within the prime slice of the corpus. The prime slice count may be displayed in connection with content submitted by the user and/or in a user profile of the user.

A prime slice ratio for a user may be calculated. The prime slice ratio may be a ratio of the prime slice count of the user to the total number of submissions of the user. The prime slice count may be displayed in connection with content submitted by the user and/or in a user profile of the user.

A user interface may be provided to display content submitted by a user. The interface may include indicators of the quality rating, the prime slice count, and/or the prime slice ratio. The indicators may include text, graphics, or the like.

The quality rating indicator may identify the subset of highest-rated items used to calculate the quality rating (e.g., may include an indication that the subset includes the top 10% rated items submitted by the user). A quality rating graphic may include a plot of the ratings of the items submitted by the user. The indicator identifying the subset of highest-rated items may be displayed on the plot.

The prime slice count and/or prime slice ratio may be depicted in a graphic. The graphic may be a chart indicative of the total number of submissions of the user, and a portion of the chart may indicate the number of user-submitted items that are within the prime slice (e.g., the prime slice count). For example, a pie chart may represent the total number of submissions of the user, and a slice of the pie chart may indicate the number of user submissions within the prime slice.

### BRIEF DESCRIPTION OF THE DRAWINGS

FIG. 1 is one embodiment of a user profile comprising an indicator of a user-contributor rating index;

FIG. 2 is one embodiment of an interface configured to display user-contributed content in connection with a user-contributor rating index;

FIG. 3 is one embodiment of a graphical indicator of a user-contributor rating index;

FIG. 4 is a flow diagram of one embodiment of a method for calculating a user-contributor rating index; and

FIG. 5 depicts one embodiment of a system for providing a user profile comprising a user-contributor rating index.

### DETAILED DESCRIPTION OF PREFERRED EMBODIMENTS

Websites and services (collectively websites) featuring user-contributed content have become very popular and are among the fastest growing websites on the Internet. Many of these websites rely on the quality of the content submitted by their users (e.g., the user “community” of the website) to attract and retain users. As such, websites featuring user-contributed content may wish to induce their users to submit high-quality content.

As used herein, content and/or metadata submitted to a website may be referred to as a “content item” or “item” and may include, but is not limited to: an image, an illustration, a drawing, a pointer (e.g., a link, uniform resource indicator (URI), or the like), a map or location-centric content, video content, Adobe Flash® content, audio content (e.g., a podcast, music, or the like), text content, a game, downloadable content, metadata content, a blog post or entry, a collection and/or arrangement of content items (e.g., into a time-sequence, such as a story or other arrangement), or any other user-authored content. In addition, a content item may include, but is not limited to: a text posting in a threaded or un-threaded discussion or forum, a content item (as defined above) posting in a threaded or un-threaded discussion, a user-submitted message (e.g., forum mail, email, etc.), or the like.

As used herein, a website may refer to a collection of renderable content comprising images, videos, audio, and/or other digital assets that are accessible by a plurality of users over a network. A website may be published on the Internet, a local area network (LAN), a wide area network (WAN), or the like. As such, a website may comprise a collection of webpages conforming to a rendering standard, such as hypertext markup language (HTML), or the like, and may be renderable by a browser, such as Microsoft Internet Explorer®, Mozilla Firefox®, Opera®, or the like. In addition, as used herein, a website may refer to a content provider service, such as a photo service (e.g., iStockphoto®, Getty Images®, etc.), a news service (e.g., Reuters, Associated Press, etc.), or the like.

Although the term “website” is used as a singular term herein for clarity, the disclosure is not limited in this regard. A website could refer to a collection of a plurality of websites. Moreover, as used herein, a “user” may refer to a user identity on a particular website and/or a user identity that may span multiple websites. The “user,” therefore, may refer to a “user account” on a particular website and/or a user identity that may be independent of any particular website, such as a Google® Account, a Microsoft Passport identity, a Windows Live ID, a Federated Identity, an OpenID® identity, or the like. Accordingly, a user and/or a “user community,” as used herein, may refer to a collection of users within a single website and/or a collection of users that may span multiple websites or services.

Users may also contribute metadata to the website; the metadata may be adapted to describe one or more content items on the website. Metadata may include, but is not limited to: a content item title, a content item caption text (e.g., a description of the content item), technique/authoring descriptive text (e.g., a description of the techniques used to author the content item), metadata tags associated with the content item, or any other data used to describe, categorize, and/or provide context to a content item.

In some embodiments, a website featuring user-contributed content may encourage quality submissions by allowing community users to rate and/or critique user-contributed content (e.g., submitted content items and/or metadata). These user-submitted ratings may be displayed in connection with the user-contributed content. The submitter of the content may want to be sure that his/her submissions receive high ratings from other users in the user community, which in turn may encourage the submitter to increase the quality of his/her submissions to the website.

In addition, many community-content driven websites allow their users to create user accounts comprising “user profiles.” A user profile may include information about a user. Some portions of the user profile may be authored by the individual users (e.g., user name, contact, information, user photo, avatar, and so on), while other portions may be automatically determined by the website or service. For example, the website may calculate an overall rating of content submitted by the user. The overall rating may be an average of the ratings given to the content submitted by the user. In some embodiments, the average may be weighted by respective user rating weights. Systems and methods for calibrating user rating weights are described in co-pending application Ser. No. ______ (attorney docket No. 38938/11), filed on Aug. 12, 2009, and entitled “Systems and Methods for Calibrating User Ratings,” which is hereby incorporated by reference in its entirety. A user who provides accurate ratings may be assigned a high user rating, and a user who submits inaccurate ratings may be assigned a low user rating, and so on.

The user profile, and the associated user rating, may be displayed with and/or linked to content submitted by the user. In some embodiments, the user profile may be displayed in-line with user-submitted content (e.g., within the same interface used to display the user-submitted content). As such, other users in the community may be given easy and pervasive access to the user-contributor's overall user rating.

Since users' rating information may be prominently displayed in conjunction with user-submitted content, submissions by highly-rated users may be given greater weight and attention than submissions from lower-rated users by other website users. This may create “peer-pressure” type motivation encouraging users to submit high-quality content to the website

However, an overall, average user rating may provide an incomplete or inaccurate picture of the user's abilities. For example, a user may have submitted a few very high quality, highly rated content items to the website, but may have also submitted a large number of low- or average-rated content items. As such, the resulting overall rating of the user may in the “average” or “below average range,” which may not accurately reflect the user's ability to produce high quality content or the value to the community of the high-quality content submitted. Moreover, the user's overall rating may be indistinguishable from other users who, for example, consistently submit low or average rated work to the website.

Disclosed herein are systems and methods for generating a user-contributor rating index that may comprise multiple rating factors, which may provide a more accurate and complete indication of the quality of a particular user-contributor's better-quality submitted content. For example, a user-contributor rating index may be derived from an average rating of the highest-rated content items submitted by the user (e.g., the user-contributor rating index may be derived from a subset of the user-contributor's highest-rated work). The subset may comprise a certain number of the user's top-rated submissions; alternatively, the rating may be derived from a threshold percentile of the user's submissions (e.g., the top 10% of the user's submissions).

A user-contributor rating index may provide an easy-to-digest summary of the content submitted by a user. In some embodiments, a user-contributor rating index may include several different types of information including but not limited to: a quality index rating, which may provide an average rating of a particular segment of the user's contributions (e.g., an average rating of the user's top submissions); a prime slice count, which may indicate the number of user submissions rated within a top-rated segment of the website; and a prime slice ratio, which may comprise a ratio of the prime slice count to the total number of submissions by the user.

In some embodiments, the user-contributor rating index may include quality ratings in a number of different rating categories and/or may include a quality rating for different content types (e.g., submitted content, metadata, and so on). User-submitted content may be rated on a number of different rating categories or aspects. In addition, user-submitted metadata associated with content may be rated. Therefore, a rating may include a combination of several different rating categories. For example, a content item may be rated based on its subject appeal, aesthetic appeal, technical merit, and the like. Similarly, metadata associated with a content item may be rated for its relevance, accuracy descriptiveness, and so on.

Ratings received from a plurality of different users may be combined into an overall rating of each of the various ratings categories aspects of the content and/or metadata (e.g., an overall “technical merit” rating, an overall “subject appeal” rating, and so on). As discussed above, the overall ratings may be calculated using the user-submitted ratings.

The various overall ratings may be combined into an aggregate rating of the content item. In some embodiments, the overall ratings may be weighted relative to one another (e.g., the technical merit overall rating may factor more heavily in the aggregate rating than a subject appeal overall rating). The metadata associated with a content item may have a separate aggregate rating, which may comprise a combination of one or more metadata rating categories. Alternatively, the aggregate rating of a content item may include the metadata ratings.

Accordingly, a user-contributor rating index may include rating information from various rating categories (e.g., an index for “technical merit,” “subject appeal,’ metadata rating categories, and so on). In some embodiments, the user-contributor rating index may include a plurality of quality rating values, one for each relevant rating category (e.g., a quality rating value for “technical merit,” “subject appeal,” and so on). Similarly, multiple prime slice counts and prime slice ratios may be calculated.

The user-contributor rating index disclosed herein may also include an indication of the total number of user-submitted content items that are ranked within a top portion of all content submitted to the website. This factor may be referred to as a “prime slice” count. As used herein, a “prime slice” may refer to a portion of top-rated content on a website. For example, a prime slice could comprise the top threshold percentile of the content items on the website (e.g., top 10% rated content items submitted to the website). A website may include a plurality of prime slices, one for each of a plurality of different rating categories, including, but not limited to: an aggregate rating prime slice count comprising a set of content items having top aggregate ratings, a “technical merit” prime slice count comprising a set of content items having top “technical merit” ratings, a “descriptiveness” prime slice comprising a set of metadata having top “descriptiveness” ratings, and so on.

The user-contributor rating index may include a prime slice count that indicates the number of content items submitted by the user that fall within one or more prime slices of the website. For instance, if a particular user had made a number of submissions to the website, eight of which are rated within the prime slice of the website corpus (e.g., top 10% of content submitted to the site), the user's prime slice count would be eight. As discussed above, a user may have multiple prime slice counts, one for each of a plurality of different rating categories (e.g., eight submissions in the aggregate prime slice, 10 submissions in a “subject appeal” prime slice, and so on).

A user-contributor rating index may include a prime slice ratio. As used herein, a prime slice ratio may indicate the number of user-submissions rated within a prime slice of the website in proportion to the total number of submissions by the user. One example of an equation to calculate a prime slice ratio is provided below:

$$P S R = \frac{prime - slice\_count}{total\_user \_submissions} \qquad Eq . 1$$

In Equation 1, PSR may represent a user prime slice ratio, the prime slice_count may represent the number of user-submitted content items within a website prime slice, and the total_user submissions may represent the total number of user-submissions. For example, a user submitting a total of one-hundred twenty content items, eight of which are rated to be within the website prime slice may be assigned a prime slice ratio of (8/120), or 0.067 (i.e., 6.7%). The prime slice ratio may provide an easy-to-digest indication of a quality consistency of content items and/or metadata submitted by user (e.g., a high prime slice ratio may indicate that the user consistently submits high-quality content to the website). In some embodiments, the total_user_submissions_value may be limited to the user submissions that are eligible for inclusion in the prime slice. For instance, if a user has submitted ten photographs that can be rated for “subject appeal” and ten items of metadata describing the photographs, the total_user_submissions value for a “subject appeal” prime slice ratio would be ten. Separate prime slice ratios may be calculated for user-submitted content items and user-submitted metadata. Similarly, separate prime slice ratios may be calculated for various different rating categories. Alternatively, or in addition, a prime slice ratio may reflect a combination of the user-submitted content items and metadata in various rating categories (e.g., be based on a combination of the user-submitted content item and metadata ratings in various rating categories).

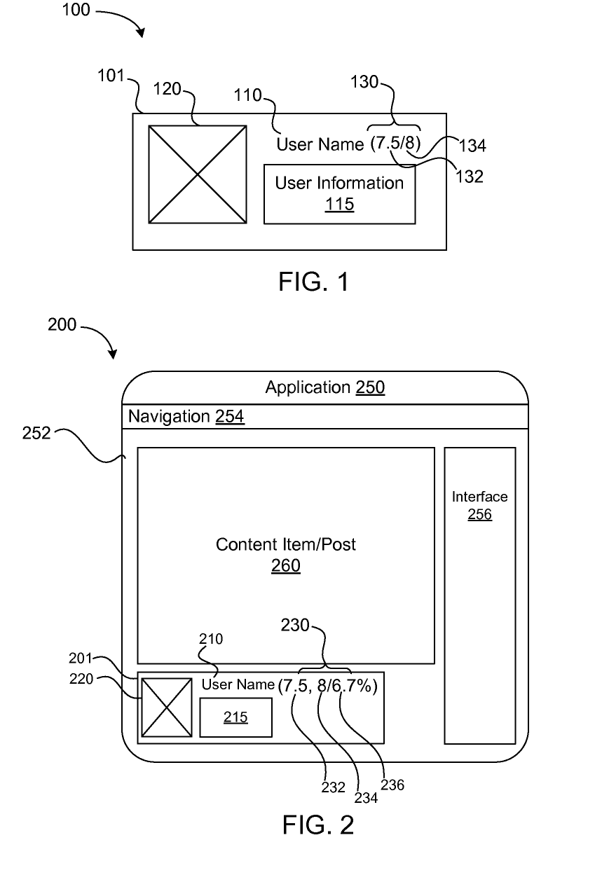

FIG. 1 depicts one embodiment of a display interface 100 configured to display user profile information 101. The interface 100 may include an indicator of a user-contributor rating index indicator 130. The user profile information 101 may include a user name 110, user information 115 (e.g., description, contact information, or the like), an avatar 120, and a user-contributor rating index indicator 130.

The user name 110 may be the registered user name or other identifier (e.g., OpenID® identifier) of the user and may comprise a text string, image, or the like. The user name 110 may be associated with user information 115, which may comprise a user-provided description, motto, contact information (e.g., email address, instant messenger name, or the like), biographical information, and the like.

The avatar 120 may comprise an image, video, audio, or any other content item and may serve as a depiction or descriptor of the user. The avatar 120 may comprise a realistic or stylized image of the user. Alternatively, the avatar 120 may be a whimsical image or other content item used to identify or distinguish the user in a user community.

The user-contributor rating index indicator 130 may comprise a quality rating indicator 132 and a prime slice count indicator 134. As discussed above, the quality index rating displayed in the indicator 132 may be derived from a subset of the user's top-rated submissions to the website. For example, the quality index rating may be an average rating of subset comprising a threshold percentile (e.g., top rated 10%) of the submissions of the user. In some embodiments, the quality rating indicator 132 may include a display indicating additional information about the average quality rating 132. For example, the average quality rating indicator 132 may show that the average quality rating 132 was derived from the top 10% rated content items and/or metadata items submitted by the user. In this case, the average quality rating indicator 132 may read “7.5 in top 10%.”

The user-contributor rating index indicator 130 may also include a prime slice count indicator 134. As discussed above, a prime slice count may be derived from the number of user-submitted content items and/or metadata items that are rated within a prime slice of all the content items and/or metadata items submitted to the website. For example, if the prime slice of the website consisted of the top 10% rated content items and/or metadata submitted to the website, a prime slice count of eight (as shown in indicator 134) may indicate that eight of the content items submitted by the user are rated within the top 10% of the website corpus.

Although FIG. 1 depicts the user-contributor rating index indicator 130 comprising a single average quality rating 132 and a single prime slice count 134, the user-contributor rating index 130 could be configured to comprise any number of rating indexes. As discussed above, the user-contributor rating index indicator 130 could include rating information related to different ratings categories and/or ratings of different content types (e.g., content items and metadata). For example, the user-contributor rating index indicator 130 could include two quality rating indicators and two prime slice count indicators; the first average quality rating and prime slice count may be directed to content item submissions of the user; and the second average quality rating and prime slice count may be directed to metadata submitted by the user. Alternatively, or in addition, the user-contributor rating index indicator 130 may comprise quality ratings and/or prime slice counts directed to various content item and/or metadata rating categories.

FIG. 2 depicts one embodiment of an interface 200 configured to display a user profile display 201 comprising a user-contributor rating index 230 used in conjunction with an application 250. The application 250 may comprise web browser software, such as Microsoft Internet Explorer®, Mozilla Firefox®, Opera®, or the like. The application 250 may be configured to display content formatted according to the Hypertext Markup Language (HTML) standard, Extensible Markup Language (XML) standard, and/or another standard (e.g., Portable Document Format (PDF) or the like). In an alternative embodiment, the application 250 may comprise media player and/or presentation software, such as Windows Media Player®, Winamp®, or the like. The application 250 may comprise a navigation component 254, which may be used to enter a URI to access a website (e.g., a server communicatively coupled to a network, such as the Internet) and/or to navigate within a website and/or network. The URI may be formed according to RFC 1630, 1738, 2396, 2732, 3986, or a related standard, and may comprise a domain name indicator (e.g., www.example.com), which may be used to access content located on a network.

The application 250 may comprise a display area 252 in which, such as HTML or other renderable data, may be presented to a user. The display 252 may comprise an interface 256, configured to allow users of the application 250 to access content on the website. As such, the interface 256 may comprise a search component (not shown) to allow a user to search for a content item, post, and/or metadata on the website using one or more search terms, keywords, and/or metadata tags. A search module of the website and/or external search service may compare the one or more search terms to, inter alia, content metadata to determine a match.

A content item or post 260 may be presented on the display 252. As discussed above, a user-submitted content item or post 260 may include, but is not limited to: an image, an illustration, a drawing, pointer (e.g., a link, URI, or the like), video content, Adobe Flash® content, audio content (e.g., a podcast, music, or the like), text content, a game, downloadable content, metadata content, a blog post or entry, a collection and/or arrangement of content items, or any other user-authored content. In addition, a content item or post 260 may include, but is not limited to: a text posting in a threaded or un-threaded discussion or forum, a content item (as defined above) posting in a threaded or un-threaded discussion, a user-submitted message (e.g., forum mail, email, etc.), or the like.

The content item or post 260 may be contributed by a user of the website (e.g., submitted by a user having a user account and user profile on the website). User profile information of the user may be displayed in a user profile display 201. In some embodiments, the interface 200 (or a similar interface) may be configured to display user profile information in connection with all content and/or submissions may be the user. As described above, the user profile display 201 may include a user name 210 of the user-contributor, user information 215, a user avatar 220, and a user-contributor rating index indicator 230. The user-contributor rating index indicator 230 may include a quality rating indicator 232, a prime slice count indicator 234, and a prime slice ratio indicator 236.

As discussed above, the quality rating displayed in the indicator 232 may be derived from a subset of content items and/or metadata submitted by the user. The quality rating may be an average rating of a subset of the top rated submission of the user.

The prime slice count indicator 234 may show the number of user-submitted content items and/or metadata within a prime slice of the website (e.g., within the top 10%, top 100,000, or the like of all the content items and/or metadata submitted to the website). For example, the prime slice indicator 234 of FIG. 2 shows that the eight of the content item and/or metadata submissions of the user have been rated within the prime slice of the website.

The prime slice ratio indicator 236 may show a ratio or percentage of user-submissions within a website prime slice to the total number of user submissions user. For example, as discussed above, if a user were to submit one-hundred twenty content items, eight of which are within the website prime slice, the resulting prime slice ratio would be 0.067 or 6.7%.

As shown in FIG. 2, the interface 200 may include the user profile display 201 in connection with the content item or post 260. As such, other users of the website may have easy and pervasive access to the user-contributor rating information shown in the indicator 230. Since the user-contributor rating index 230 may be displayed in conjunction with the content and/or posts submitted by the user, the user may be motivated to submit content items and/or metadata of the highest quality to increase his/her user-contributor rating index. In addition, since the user-contributor rating index may comprise multiple factors, such as the average quality rating, the prime slice count, and/or the prime slice ratio, the user-contributor rating index 230 may provide other users with an accurate and easy-to-digest indication of the quality and consistency of the user's contributions to the website.

In addition, as discussed above, the user-contributor rating indicator 230 may be adapted to include a plurality of rating indexes, which may be separately directed to content-items and/or metadata submitted by the user. Alternatively, or in addition, the user-contributor rating index indicator 230 may comprise a plurality of rating indexes directed to one or more content item and/or metadata rating categories. For example, audio content items may be rated based upon “beat,” “melody,” and/or “tone” rating categories. Metadata may be rated using categories, such as “descriptiveness,” “relevance,” or the like. In this case, the user-contributor rating index indicator 230 could comprise an average quality rating directed to “beat,” and average quality rating directed to “melody,” and so on. In addition, the user-contributor rating index indicator 230 could comprise a prime slice count and/or prime slice ratio directed to the “beat,” “melody,” and/or “tone” rating categories. Similarly, the user-contributor rating index indicator 230 could include multiple rating categories related to metadata ratings (e.g., average and/or prime slice count/ratio rating indexes directed to metadata “descriptiveness,” “relevance,” and so on).

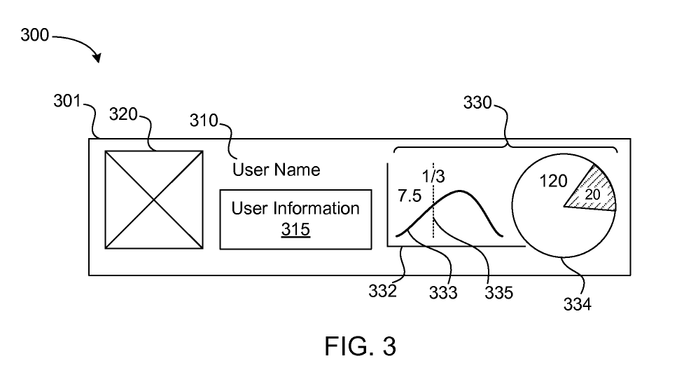

FIG. 3 depicts an embodiment of an interface 300 configured to provide a user profile display 301 comprising a graphical user-contributor rating index. The user profile display 301 may include a user name 310, user information 315, an avatar 320, and a user-contributor rating index indicator 330. The user name 310 may be the registered user name of the user and may comprise a text string, image, or the like. The user name 310 may be associated with user information 315, which may comprise a user-provided description, motto, contact information (e.g., email address, instant messenger name, or the like), biographical information, and the like.

The avatar 320 may comprise an image, video, audio, or any other content and may serve as a depiction or descriptor of the user. The avatar 320 may comprise a realistic or stylized image of the user. Alternatively, the avatar 320 may be a whimsical image or other content used to identify or distinguish the user.

The user-contributor rating index indicator 330 may provide a quality rating graphic 332 and a prime slice graphic 334. The quality rating graphic 332 may provide a visual depiction of the average quality rating (e.g., 7.5 in FIG. 3). The graphic 332 may provide additional information about how the quality rating was derived, such as the range of user-contributed content items included in the quality rating, a curve showing the rating distribution of the user, and the like. In the FIG. 3 example, a rating distribution curve 333 shows a distribution of the ratings of user-submitted content items and/or metadata (e.g., the curve 333 may be a histogram-style showing the distribution of ratings the content submitted by the user). An indicator 335 may be provided on the rating distribution curve 333 to identify which user-contributed content item ratings were used to calculate the average quality rating. In FIG. 3, the indicator 335 shows that the top ⅓ rated submissions were used to derive the quality rating. The graphical indicator 332 of the quality rating information may allow a viewer to quickly and easily interpret the quality rating information provided on the interface 300.

The prime slice graphic 334 may comprise a graphical representation of the number of user-submissions that fall within a prime slice of the website. In the FIG. 3 example, the prime slice graphic 334 is shown as a pie chart indicator, which shows the number user-submissions within the prime slice (twenty submissions). The graphic 334 also includes prime slice ratio information. The prime slice graphic 334 graphically depicts the ratio of the submissions within the prime slice (20) to the total number of user submissions (120). As such, the prime slice graphic 334 may convey both the prime slice and prime slice ratio in a single, easy-to-digest, graphical format.

Although FIG. 3 depicts the quality rating indicator 332 in a rating distribution curve 333 and uses a pie chart as the prime slice graphic 334, one skilled in the art would recognize that any number of visualization and/or charting means could be used to convey user-contributor rating index information under the teachings of this disclosure including, but not limited to: scatter graphs, linear graphs, area charts, bar charts, statistical distributions, histograms, and the like. In addition, the graphical user-contributor rating index indicator 330 could be modified to include multiple indicators and/or graphics directed to various rating categories and/or to ratings of various content types (e.g., different content item types, metadata, and so on). Accordingly, the graphical rating indicator 330 should not be read as limited to any particular number of graphical rating categories provided using any particular type of graphical display.

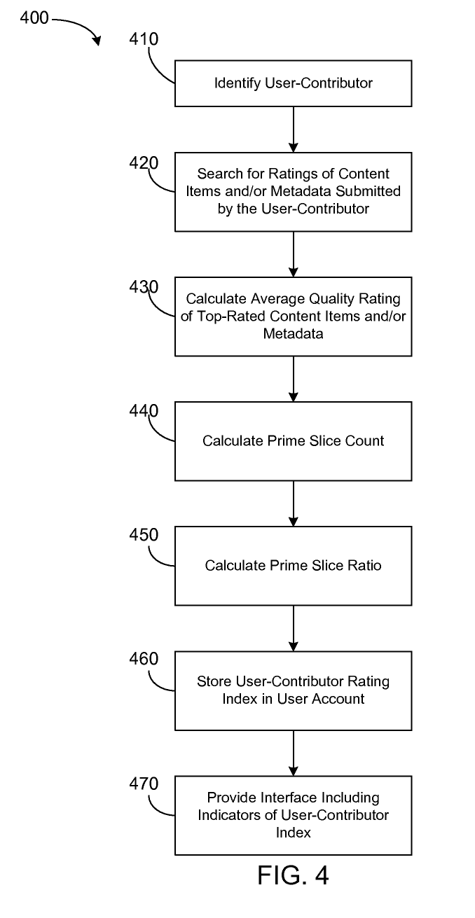

FIG. 4 is a flow diagram of one embodiment of a method for calculating a user-contributor rating index. The method 400 may comprise one or more machine executable instructions stored on a computer-readable storage medium. The instructions may be configured to cause a machine, such as a computing device, to perform the method 400. In some embodiments, the instructions may be embodied as one or more distinct software modules on the storage medium. One or more of the instructions and/or steps of method 400 may interact with one or more hardware components, such as computer-readable storage media, communications interfaces, or the like. Accordingly, one or more of the steps of method 400 may be tied to particular machine components.

As discussed above, user-contributor rating index information may be based upon various rating categories, such as an aggregate rating of the user submissions, category-specific ratings, content type ratings (e.g., photographic content, video content, metadata, and so on), and the like. Therefore, a user-contributor rating index as disclosed herein may include one or more quality ratings (e.g., for various content types and/or rating categories), one or more prime slice counts, and/or one or more prime slice ratios. Therefore, although for clarity the method 400 is described as generating a single set of user-contributor rating index information (e.g., a single quality rating, prime slice count, and/or prime slice ratio), the method 400 could be adapted to generate user-contributor rating index information comprising any number of quality ratings, prime slice counts, and/or prime slice ratios based upon any number of different types of ratings.

At step 410, a user-contributor may be identified and/or selected. The identification and/or selection of 410 may comprise receiving a user name and/or user identifier (e.g., OpenID® identifier, Windows Live ID, or the like) of a contributor to a website. The identification may allow a user account information of the user to be accessed (e.g., in a computer-readable storage medium, database, directory, or the like). The user-contributor identified and/or selected at 410 may be the subject of the user-contributor rating index generated and/or updated using method 400.

At step 420, ratings of content submitted by the user identified at step 410 may be accessed. The accessing of step 420 may include searching a data storage module (e.g., computer-readable storage medium, database, directory, index, etc.) for rating information. The rating information may be derived from user-submitted ratings of content submitted by the user. As discussed above, the ratings may be in one or more rating categories. A plurality of user-submitted ratings may be combined into one or more overall ratings and/or into an aggregate rating. The ratings may be weighted according to a rating weight of the users.

At step 430, one or more quality ratings for the user-contributor may be calculated using the ratings obtained at 420. The ratings may be selected from an appropriate category and/or from ratings of a particular content type. Calculating a quality rating may comprise selecting a subset of the ratings identified at step 420. The subset may include a set of top rated content items of the user. The subset may be predefined (e.g., top 10%), may be adaptive (e.g., ratings within a threshold deviation of a rating mean), or the like. In the FIG. 4 example, the subset may be all ratings that are above one standard deviation of the mean of a normal distribution of the user ratings.

At step 440, one or more prime slice counts may be calculated. As discussed above, a prime slice count may indicate the number of content items and/or metadata items submitted by the user that are rated within a top-tier (e.g., prime slice) of submitted content. Calculating a prime slice may comprise identifying the top-tier of the submitted content. The top-tier may be a pre-defined threshold (e.g., top 10%), an adaptive threshold (e.g., ratings above a threshold mean and/or deviation of the mean of the submission ratings), or the like. After the top-tier is identified, a prime slice selection criteria may be determined. The criteria may include a rating threshold or some other criteria. Each relevant user submission may be compared to the prime slice selection criteria, and a prime slice count of the user may be incremented for each user submission that satisfies the selection criteria.

At 450, a prime slice ratio may be calculated. As discussed above, this may comprise calculating a ratio of the prime slice count of the user to the total number of eligible submissions by the user. An eligible submission may be any user-submission that is eligible for selection within a prime slice. For example, in a prime slice of photographic content, only submissions of photographs may be considered to be “eligible submissions,” and, as such, submissions of other types of content may not be used to calculate the prime slice ratio.

At 460, the user-contributor index information including the quality rating of step 430, the prime slice count of step 440, and/or the prime slice ratio of step 450 may be made available for use by the website. Making the user-contributor index information available may include storing the information in a computer-readable storage medium and/or linking the information to a user account and/or user profile of the user-contributor (e.g., the user identified at step 410). In this way, the user-contributor rating index may be available for presentation on a user-profile without being recalculated. The user-contributor rating index may be recalculated when necessary (e.g., when the user contributor submits additional content items and/or metadata, new ratings of the user-contributor's content items and/or metadata items are submitted, or the like).

At step 470, the method may provide an interface configured to display content submitted by the user. The interface may be similar to the interface 200 described above in conjunction with FIG. 2. The interface provided at step 470 may display user contributed content, posts, or any other user-contributed content (e.g., metadata, etc.). The interface may include indicators of the user-contributor index information, such as the quality rating, the prime slice count, and/or the prime slice ratio. The user-contributor rating index information may be provided within the interface as graphical indicators as shown in FIG. 3. Alternatively, or in addition, the information may be conveyed using text, audio, or other means. The interface may include and/or be linked to a user profile display. The indicators of the user-contributor rating index information may be provided in the user profile display (e.g., as shown in FIGS. 1, 2, and 3). Alternatively, or in addition, the indicators may be displayed independently of other user profile information.

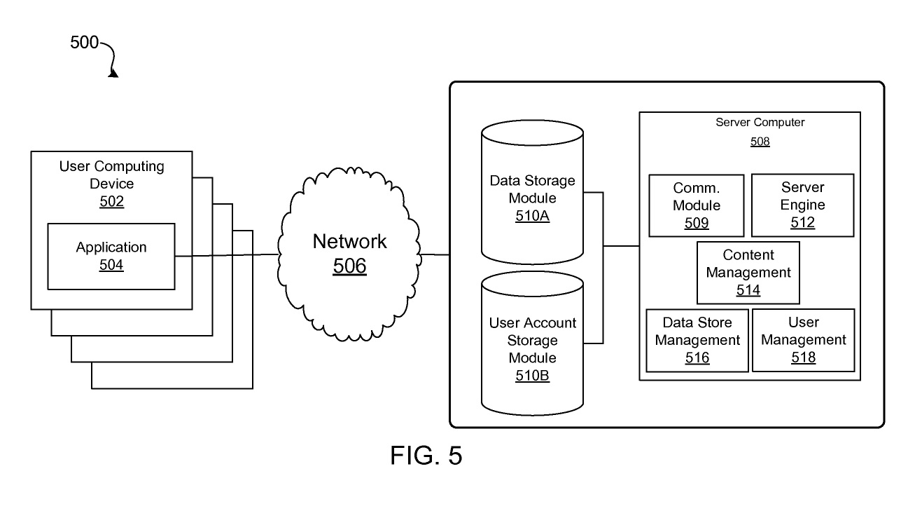

Aspects of the teachings of this disclosure may be practiced in a variety of computing environments. FIG. 5 depicts one embodiment of a system for generating, maintaining, and/or providing for displaying user-contributor rating index information. The one or more user computing devices 502 may comprise an application 504 that may be used to access and/or exchange data with other computing devices on the network 506, such as the server computer 508. The application 504 may comprise a web browser, such as Microsoft Internet Explorer®, Mozilla Firefox®, Opera®, or the like. Alternatively, or in addition, the application 504 may comprise a media player and/or content presentation application, such as Adobe Creative Suite®, Microsoft Windows Media Player®, Winamp®, or the like. The user computing device 502 and/or the application 504 may comprise a network interface component (not shown) to allow the application 504 to communicate with and/or access content made available by the server computer 508 via the network 506. For example, Adobe Creative Suite® may provide access to a stock photo repository to allow users to purchase content for integration into an Adobe® project; a media player, such as Microsoft Windows Media Player®, may provide access to an online, streaming music to allow a user to purchase audio content therefrom; and a web browser may provide access to web accessible content on the network 506.

The application 504 may allow a user to access websites or other content accessible via a Transmission Control Protocol (TCP) Internet Protocol (IP) network (i.e., a TCP/IP network). One such network is the World Wide Web or Internet. One skilled in the art, however, would recognize that the teachings of this disclosure could be practiced using any networking protocol and/or infrastructure. As such, this disclosure should not be read as limited to a TCP/IP network, the Internet, or any other particular networking protocol and/or infrastructure.

The user computing devices 502 may comprise other program modules, such as an operating system, one or more application programs (e.g., word processing or spreadsheet applications), and the like. The user computing devices 502 may be general-purpose and/or specific-purpose devices comprising a processor, memory, computer-readable storage media, input-output devices, communications interfaces, and the like. The computing devices 502 may be adapted to run various types of applications, or they may be single-purpose devices optimized or limited to a particular function or class of functions. Alternatively, the user computing devices 502 may comprise a portable computing device, such as a cellular telephone, personal digital assistant (PDA), smart phone, portable media player (e.g., Apple iPod®), multimedia jukebox device, or the like. As such, this disclosure should not be read as limited to any particular user computing device implementation and/or device interface. Accordingly, although several embodiments herein are described in conjunction with a web browser application, the use of a web browser application and a web browser interface are only used as a familiar example. As such, this disclosure should not be read as limited to any particular application implementation and/or interface.

The network 506 may comprise routing, addressing, and storage services to allow computing devices, such as the user computing devices 502 and the server computer 508 to transmit and receive data, such as web pages, text content, audio content, video content, graphic content, and/or multimedia content therebetween. The network 506 may comprise a private network and/or a virtual private network (VPN). The network 506 may comprise a client-server architecture, in which a computer, such as the server computer 508, is dedicated to serving the one or more user computing devices 502, or it may have other architectures, such as a peer-to-peer, in which the one or more user computing devices 502 serve simultaneously as servers and clients. In addition, although FIG. 5 depicts a single server computer 508, one skilled in the art would recognize that multiple server computers 508 could be deployed under the teachings of this disclosure (e.g., in a clustering and/or load sharing configuration). As such, this disclosure should not be read as limited to a single server computer 508.

The server computer 508 may be communicatively coupled to network 506 by a communication module 509. The communication module 509 may comprise one or more wired and/or wireless network interfaces capable of communicating using a networking and/or communication protocol supported by the network 506 and/or the user computing devices 502.

The server computer 508 may comprise and/or be communicatively coupled to a data storage module 510A. Data storage module 510A may comprise one or more databases, XML data stores, file systems, X.509 directories, LDAP directories, and/or any other data storage and/or retrieval systems known in the art. Accordingly, the data storage module 510A may include disc storage devices (e.g., hard discs), optical storage devices, or the like. The data storage module 510A may store web pages and associated content (e.g., user submitted content) to be transmitted to one or more of user computing devices 502 over network 506.

The server computer 508 may comprise a server engine 512, a content management module 514, and a data storage management module 516. The server engine 512 may perform processing and operating system level tasks including, but not limited to: managing memory access and/or persistent storage systems of the server computer 508, managing connections to the user computing device(s) 502 over the network 506, and the like. The server engine 512 may manage connections to/from the user computing devices 502 using a communication module (not shown).

The content management module 514 may create, display, and/or otherwise provide content to user computing device(s) 502 over network 506. In addition, and as will be discussed below, the content management module 514 may manage user profile information and user-submitted content displayed to or received from user computing devices 502. Data storage management module 516 may be configured to interface with the data storage module 510A to store, retrieve, and otherwise manage data in the data storage module 510A.

In some embodiments, the server engine 512 may be configured to provide data to the user computing devices 502 according to the HTTP and/or secure HTTP (HTTPS) standards. As such, the server computer 508 may provide web page content to the user computing devices 502. Although the server computer 508 is described as providing data according to the HTTP and/or HTTPS standards, one skilled in the art would recognize that any data transfer protocol and/or standard could be used under the teachings of this disclosure. As such, this disclosure should not be read as limited to any particular data transfer and/or data presentation standard and/or protocol.

The user computing devices 502 may access content stored on the data storage module 510A and made available by a content management module 514 via a URI addressing the server computer 508. The URI may comprise a domain name indicator (e.g., www.example.com) which may be resolved by a domain name server (DNS) (not shown) in the network 506 into an Internet Protocol (IP) address. This IP address may allow the user computing devices 502 to address and/or route content requests through the network 506 to the server computer 508. The URI may further comprise a resource identifier to identify a particular content item on the server computer 508 (e.g., content.html).

Responsive to receiving a URI request, the server engine 512 may be configured to provide the content to the user computing device 502 (e.g., web page) identified in the URI. The content management module 514 and a data storage management module 516 may be configured to obtain and/or format the requested content to be transmitted to the user computing device 502 by the server engine 512.

Similarly, the server engine 512 may be configured to receive content submitted by a user via the one or more user computing devices 502. The user-submitted content may comprise a content item, such as an image, a video clip, audio content, or any other content item. The user-submitted content may be made available to other users via the one or more user computing devices 502 via the server computer 508. User-submitted content may further include metadata, commentary, and the like. For example, users may submit ratings of content available on the server computer 508. The ratings may be received by the server computer 508 and may be used to generate user-contributor rating index information as described above.

The server computer 508 may comprise a user management module 518. The user management module 518 may access the user account data storage module 510B, which may comprise one or more user accounts relating to one or more users authorized to access and/or submit content to the server computer 508. The user account data storage module 510B may comprise user profile information. As discussed above, a user profile may comprise a user password, content accessed by the user, content submitted by the user, ratings of the content submitted by the user, user-contributor rating index information, and the like.

The user management module 518 may be configured to generate and maintain user-contributor rating index information. As discussed above, user-contributor rating index information may include: an average quality rating for a finite number of top-rated user-contributed content and/or metadata; a prime slice count indicating the number of user-submitted content items and/or metadata within the prime slice of the website (e.g., within the top-rated 10% of all content and/or metadata submitted to the website); a prime slice ratio comprising a ratio between the number of user-submitted content items and/or metadata rated within the prime slice of the website to the total number of content items and/or metadata submitted by the user; and the like. The user management module 518 may be configured to generate a single set of user-contributor rating index information (e.g., a single quality rating, prime slice count, and/or prime slice ratio), generate separate content item and metadata user-contributor rating index information, and/or may multiple sets of user-contributor rating index information directed to various content item and/or metadata rating categories.

The user management module 518 may calculate the user-contributor index information as described above. The module 518 may access ratings of user-contributed content (stored on the data storage module 510A and/or obtained from the content management module 514), determine a subset of the top-rated submissions (e.g., top 10%), and calculate a quality rating using the subset. In addition, the user management module 518 may identify a prime slice of the website (e.g., in the data storage module 510A and/or using the content management module 514). Prime slice selection criteria may be determined, which may be used to identify a prime slice count and/or prime slice ratio. The user-contributor information may be stored on the user account storage module 510B and made available to the server computer 508 for display to the user computing devices 502.

The server engine 512 may be configured to provide various interfaces configured to display user-submitted content on the user computing devices 502. The interfaces provided by the server engine 512 may be configured to display user-contributor rating index information in connection with user-submitted content. The user-contributor rating index information may be displayed as one or more indicators comprising text, graphics, or other indicator types. In some embodiments, the user-contributor rating index information may be displayed in a user profile stored in the user account data storage module 510B. The items and/or user profile may be displayed in connection with content items and/or posts submitted by a particular user.

The server computer 508, the data storage module 510A, and the user account data storage module 510B may comprise security measures to inhibit malicious attacks thereon, and to preserve integrity of the messages and data stored therein. Such measures may include, but are not limited to: firewall systems, secure socket layer (SSL) communication, user authentication, public key infrastructure (PKI) authentication, password protection schemes, data encryption, and the like.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product, including a computer-readable medium having stored thereon instructions that may be used to program a computer (or other electronic device) to perform processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that perform one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention.

I claim:

1. A computer-readable storage medium comprising instructions to cause a computing device to perform a method, comprising:
accessing a plurality of items submitted by a user from a corpus of user-submitted items, each item submitted by a respective user and having a respective rating;
identifying a highest-rated subset of the plurality of items submitted by the user;
calculating a quality rating for the user, wherein the quality rating is a function of the ratings of the items in the highest-rated subset; and
providing an interface to display content submitted by the user, wherein the interface includes an indication of the quality rating of the user.

2. The computer-readable storage medium of claim 1, further comprising:
identifying a highest-rated prime slice of the corpus; and
calculating a prime slice count for the user comprising a count of user submissions included in the prime slice of the corpus.

3. The computer-readable storage medium of claim 2, wherein the interface includes an indication of the prime slice count of the user.

4. The computer-readable storage medium of claim 2, further comprising calculating a prime slice ratio based on a ratio of the prime slice count of the user to a total number of submissions of the user.

5. The computer-readable storage medium of claim 4, wherein the interface includes an indication of the prime slice count of the user and the prime slice ratio of the user.

6. The computer-readable storage medium of claim 5, wherein the indication of the prime slice count and the prime slice ratio is a graphic.

7. The computer-readable storage medium of claim 6, wherein the graphic comprises a pie chart depicting the total number of submissions of the user, and wherein a slice of the pie chart depicts the prime slice count of the user.

8. The computer-readable storage medium of claim 2, wherein the prime slice of the corpus includes items having a rating within a threshold rating percentile of the corpus.

9. The computer-readable storage medium of claim 2, wherein the prime slice of the corpus includes items having a rating greater than a threshold deviation of a mean rating of the corpus.

10. The computer-readable storage medium of claim 1, wherein the indication of the quality rating comprises a graphic, and wherein the graphic includes an indicator identifying the subset of the highest-rated items used to calculate the quality rating.

11. The computer-readable storage medium of claim 10, wherein the graphic indicator of the quality rating comprises a plot of the ratings of the plurality of items submitted by the user, and wherein the indicator specifying the subset of the highest-rated items is displayed on the plot.

12. The computer-readable storage medium of claim 1, wherein the subset of the highest-rated items comprises user submissions rated above a threshold rating percentile of the plurality of items submitted by the user.

13. The computer-readable storage medium of claim 1, wherein the subset comprises user submissions rated above a threshold deviation of a mean rating of the plurality of items submitted by the user.

14. The computer-readable storage medium of claim 1, wherein the quality rating is an average of the ratings of the items within the subset of highest-rated items.

15. A system for providing user-contributor rating index information, comprising:
a computing device comprising a processor;
a content management module operable on the processor and comprising a plurality of items submitted by a user, each item having a respective rating; and
a user management module operable on the processor and communicatively coupled to the content management module, the user management module configured to identify a highest-rated subset of the plurality of items authored by the user and to calculate a quality rating of the user as a function of the ratings in the highest-rated subset,
wherein the content management is configured to provide an interface to display content submitted by the user, the interface including an indication of the quality rating of the user.

16. The system of claim 15, wherein the content management module is configured to identify a highest-rated prime slice of a corpus comprising plurality of items, each item having a respective rating, and
wherein the user management module is configured to calculate a prime slice count for the user comprising a count of user submissions included in the price slice of the corpus.

17. The system of claim 16, wherein the interface includes an indication of the prime slice count of the user.

18. The system of claim 16, further comprising calculating a prime slice ratio as a ratio of the prime slice count of the user to a total number of submissions of the user.

19. The system of claim 18, wherein the interface includes an indication of the prime slice count of the user and the prime slice ratio of the user.

20. The system of claim 19, wherein the indication of the prime slice count and the prime slice ratio is a graphic.

21. The system of claim 21, wherein the graphic comprises a pie chart depicting the total number of submissions of the user, and wherein a slice of the pie chart depicts the prime slice count of the user.

22. The system of claim 16, wherein the prime slice of the corpus includes items having a rating within a threshold rating percentile of the corpus.

23. The system of claim 16, wherein the prime slice of the corpus includes items having a rating greater than a threshold deviation of a mean rating of the corpus.

24. The system of claim 15, wherein the indication of the quality rating comprises a graphic, and wherein the graphic includes an indicator identifying the subset of the highest-rated items used to calculate the quality rating.

25. The system of claim 24, wherein the graphic indicator of the quality rating comprises a plot of the ratings of the plurality of items submitted by the user, and wherein the indicator specifying the subset of the highest-rated items is displayed on the plot.

26. The system of claim 15, wherein the subset of the highest-rated items comprises user submissions rated above a threshold rating percentile of the plurality of items submitted by the user.

27. The system of claim 15, wherein the subset comprises user submissions rated above a threshold deviation of a mean rating of the plurality of items submitted by the user.

28. The system of claim 15, wherein the quality rating is an average of the ratings of the items within the subset of highest-rated items.

29. A computer-implemented method, comprising:
accessing a plurality of items submitted by a user from within a corpus of content items stored on a computer-readable storage medium, wherein each item in the corpus is associated with a respective submitter and has a respective rating;
identifying a highest-rated subset of the plurality of items submitted by the user;
calculating a quality rating for the user, wherein the quality rating is a function of the ratings of the items in the highest-rated subset;
identifying a highest-rated prime slice of the corpus;
calculating a prime slice count of content items submitted by the user that are within the identified prime slice; and
providing an interface to display an indication of the quality rating and the prime slice count of the user.

30. The computer-implemented method of claim 29, further comprising calculating a prime slice ratio based on a ratio of the prime slice count of the user to a total number of submissions of the user,
wherein the interface includes an indication of the prime slice ratio of the user.
